(19) United States
(12) Patent Application Publication
(10) Pub. No.: US 2021/0129736 A1
(43) Pub. Date: May 6, 2021

(54) COLLAPSIBLE CARGO MANAGEMENT DEVICE

(71) Applicant: Auria Solutions UK I, Ltd., London (GB)

(72) Inventors: Robert MAMO, Northville, MI (US); Gabriel B. BECK, JR., North Canton, OH (US); Alan Harrison, Co Mayo (IE); Ben Millett, Co. Roscommon (IE); Michael Culleton, Co. Dublin (IE)

(21) Appl. No.: 17/086,882

(22) Filed: Nov. 2, 2020

Related U.S. Application Data
(60) Provisional application No. 62/929,402, filed on Nov. 1, 2019.

(51) Int. Cl. B60P 7/14

(52) U.S. Cl. CPC B60P 7/14

(57) ABSTRACT

The present disclosure relates to cargo management devices and, particularly to cargo management devices that can transition between a collapsed state, a deployed state and, in some instances, a reinforced state.

### CROSS REFERENCE TO RELATED APPLICATION

This application claims the benefit of the filing date of U.S. Provisional Application No. 662/929,402, filed Nov. 1, 2019, the teachings of which are incorporated herein by reference.

### FIELD

The present disclosure relates to cargo management devices and, particularly, to collapsible cargo management devices.

### BACKGROUND

During transport cargo stored in the cargo area of a vehicle often shifts if it is not secured in some manner. This may annoy persons in the vehicle, damage the cargo, damage the compartment in which the cargo is located, or even cause personal injury. Cargo management devices such as nets, buckets, trays, boxes, etc. have been developed to limit or prevent movement of the cargo during transport. One example of such a cargo management device is a free-standing unit that props items against the side walls of the cargo area of the vehicle. While such devices are useful, they take up substantial space in the vehicle when not in use and may interfere with the placement of larger items in the vehicle. Accordingly, room for improvement remains in the development of cargo management devices and their storage.

### BRIEF DESCRIPTION OF THE DRAWINGS

Features and advantages of the subject matter of this disclosure, and the manner of attaining them, will become more apparent and better understood by reference to the following description of embodiments in conjunction with the accompanying drawings, wherein:

FIG. 1A illustrates a front perspective view of one example of a cargo management device consistent with the present disclosure, in a deployed state;

FIG. 1B illustrates a rear perspective view of the cargo management device of FIG. 1A, in a deployed state;

FIGS. 2A-2H schematically illustrate another example of a cargo management device consistent with the present disclosure, as it transitions between a collapsed state (FIG. 2A), a deployed state (FIG. 2E), and a reinforced state (FIG. 2H).

FIGS. 3A-3E schematically illustrate another example of a cargo management device consistent with the present disclosure, as it transitions between a collapsed (folded) state (FIG. 3A) and a deployed state (FIG. 3E);

FIGS. 4A-4D illustrate various views of another example cargo management device consistent with the present disclosure in a deployed state;

FIGS. 4E-4J illustrate various views of the cargo management device of FIGS. 4A-4D in a collapsed (folded) state;

FIGS. 5A-5C illustrate various views of another example cargo management device consistent with the present disclosure, in a collapsed (folded) state.

### DETAILED DESCRIPTION

The present disclosure relates to cargo management devices and, particularly to cargo management devices that can transition between a collapsed state, a deployed state and, in some instances, a reinforced state. The cargo management devices described herein are suitable for myriad uses, including limiting or even preventing movement (shift) of cargo placed in a cargo compartment of a vehicle, such as a trunk or passenger compartment of an automobile.

The cargo management devices generally include a base, a primary wall coupled to the base, and a foldable support coupled to the primary wall. The base includes opposing top and bottom sides, and the primary wall includes opposing first and second sides. The primary wall is coupled to the base such that a first hinge is defined between the base and the primary wall. The first hinge allows the primary wall to rotate relative to the base as the cargo management device transitions between a deployed state and a folded state, and vice versa. In the deployed state, the primary wall is oriented parallel or substantially parallel to a first axis that extends perpendicular or substantially perpendicular through the top and bottom sides of the base. In the folded position the primary wall is oriented perpendicular or substantially perpendicular to the first axis, with the first side of the primary wall facing the top of the base. Put differently, in the deployed state the primary wall extends in a vertical or substantially vertical direction, and the base extends in a horizonal or substantially horizontal direction. While various embodiments are described herein in which the primary wall is shown as being oriented at a 90 degree angle from the base in the deployed state, the primary wall may be set to intersect the base at any suitable angle relative to the base. For example, the primary wall may intersect the base at an angle that is greater than or less than 90 degrees, such as from 30 to 80 degrees or 120 to 170 degrees.

The foldable support includes a cross member and a foot, wherein the cross member and foot each include opposing first and second sides. A proximal end of the cross member is coupled to the primary wall (e.g., to the second side thereof), such that a second hinge is defined between the proximal end of the cross member and the primary wall. The foot is coupled to cross member such that a third hinge is defined between a distal end of the cross member and a proximal end of the foot. The second hinge generally functions to allow the cross member to rotate relative to the primary wall, and the second hinge generally functions to allow the foot to rotate relative to the cross member.

In the folded (collapsed) state the cross member and foot may be oriented such that they both extend perpendicular or substantially perpendicular to the first axis with their respective second sides each oriented towards the top of the base. During a transition from the collapsed state to the deployed state, the primary wall may rotate about the first hinge in a first rotational direction, the cross member may rotate about the second hinge in a second rotational direction (e.g., opposite the first rotational direction), and the foot may rotate about the third hinge in the first rotational direction. As the foot is rotated about the third hinge, the first side of the foot transitions from facing away from the top of the base to facing towards the top of the base, and the second side of the foot transitions from facing towards the top of the base to facing away from the top of the base. At the same or different time, rotation of the cross member about the second hinge reorients the second side of the of the cross member relative to the top of the base.

In the deployed state, the first side of the cross member faces (e.g., at an angle) the top of the base, the first side of the foot faces the top of the base, and the second side of the foot faces away from the top of the base. In embodiments, in the deployed state all or a portion of the first side of the foot lies on the top surface of the base, and the foot is oriented perpendicular or substantially perpendicular to the first axis. In any case, in the deployed state the cross member and foot form an angled brace for the primary wall. In embodiments when the cargo management device is in the deployed state a distal end of the foot abuts and supports the primary wall at a first position, a proximal end of the cross member abuts and supports the primary wall at a second position, and the third hinge is disposed proximate the base. In that position the cross member, foot, and third hinge all support the primary wall, e.g., against force applied to the first surface of the primary wall. Alternatively or in addition to the distal end of the foot abutting the primary wall, movement of the foot relative to the base and the primary wall may be restricted in some manner, e.g., by retention system. In embodiments the retention system includes a grommet formed through the foot, and a post coupled to the base (or a retention support) that extends through the grommet.

As an extension of such embodiments, the cargo management device may be further moveable from a deployed state to a reinforced state. In such embodiments the base may include a first base part that is coupled to a second base part, such that a fourth hinge is defined between the first base part and the second base part. In the folded and deployed states, the first and second base part are each oriented perpendicular or substantially perpendicular to the first axis. In the reinforced state, the first base part is disposed on or proximate to the first side of the cross member, while the second base part remains oriented perpendicular or substantially perpendicular to the first axis.

During a transition from the deployed state to the reinforced state the first base part rotates about the fourth hinge relative to the second base part. More particularly, once the primary wall, cross member, and foot have been brought to the deployed state, the first base part may rotate about the fourth hinge in a direction toward the primary wall, cross member, and foot, until the top of the first base part is disposed on or adjacent the first side of the cross member. Once in that position, the first base part may be retained in that position in any suitable manner. For example, the first base part may be coupled to the first side of the cross member, e.g., with magnets or other suitable fastener (e.g., a hook and loop fastener, a grommet and post fastener, a snap fit fastener, or the like). To facilitate proper rotation and positioning of the first base part in the reinforced state, the fourth hinge may be positioned such that when the foot is in the deployed state, the fourth hinge is not covered by the foot. Put differently, the fourth hinge may be positioned such that it is laterally offset from the proximal end of the foot and is not covered by the foot when the foot is the deployed state.

In other embodiments the cargo management device includes a base, a primary wall coupled to the base, a collapsible support coupled to the primary wall and a retention system. The collapsible support includes a cross member and a foot. The retention system includes a first retention element integral with or coupled to the base or a retention support on or integral with the base, and a second retention element formed on or through the foot. In embodiments, the retention system includes a grommet formed through the foot and a post that is coupled to the base or a retention support integral with or coupled to the base. The first hinge generally functions to allow the primary wall to rotate relative to the base, and toward or away from a first axis that extends perpendicularly through a top and bottom side of the base. The second hinge generally functions to allow the cross member to rotate relative to the primary wall. The third hinge generally functions to allow the foot to rotate relative to cross member.

In such embodiments when the cargo device is in the collapsed (folded) state, a first side of the primary wall is disposed on or proximate to the top of the base and the primary wall is oriented perpendicular or substantially perpendicular to the first axis. Similarly, at least a portion of a second side of the cross member is disposed on or proximate to the primary wall, and the cross member is oriented perpendicular or substantially perpendicular to the first axis. Still further, the foot is oriented perpendicular or substantially perpendicular to the first axis and is oriented such that a first side of the foot faces away from the base and a second side of the foot faces towards the base.

In these embodiments the foot is retained proximate to the base with the retention system. For example, when the retention system includes a grommet through the foot and a post integral with or coupled to the base (or a retention support), in the collapsed (folded) state the post may extend through the grommet to retain the foot proximate the base. Alternatively when the retention system is a hook and loop fastener system, the foot may be retained proximate the base by engagement of a hook or loop element on the foot with a corresponding loop or hook element on the base (or retention support). In any case, engagement of the retention system may hinder or prevent movement of the foot, cross member, and/or primary wall. For example, engagement of the retention system may hinder or prevent the foot from rotating about the third hinge, the cross member from rotating about the second hinge, and/or the primary wall from rotating about the first hinge.

The retention system may be disengaged during a transition from the collapsed (folded) state to a deployed state. For example when the retention system includes a grommet through the foot and a post integral with or coupled to the base (or a retention support), the retention system may be disengaged by decoupling the grommet from the post. That may be accomplished, for example, by pulling the foot away from the base, the base away from the foot, or both. Once the retention system is disengaged the primary wall may be rotated in a first rotational direction towards the first axis until the primary wall is oriented parallel or substantially parallel with the first axis. At the same or a different time, the cross member may be rotated in a second rotational direction relative to the first axis, and/or the foot may be rotated in the first rotational direction relative to the first axis. Rotation of the foot in the first rotational direction reorients the foot such that the second side of the foot faces away from the base, the first side of the foot faces toward the base, and the elements of the retention system are substantially aligned. The retention system may then be re-engaged.

For example, when the retention system includes a grommet through the foot and a post coupled to or integral with the base (or a retention support), rotation of the foot about the third hinge may be performed orient the first side of the foot to face the base, and to align the grommet with the post. The retention system may be re-engaged by causing the post to pass through (and optionally couple with) the grommet.

In these embodiments when the cargo retention system is in the deployed state (i.e., following re-engagement of the retention system), the cross member and foot form an angled brace for the primary wall. For example, in the deployed state a proximal end of the cross member abuts and supports a second side of the primary wall, a distal end of the cross member is coupled to the foot (e.g., at or via the third hinge), and movement of the foot is inhibited or prevented by the retention system. As a result, the cross member, third hinge, and foot support the second side of the wall, e.g., against force applied to a first side of the primary wall.

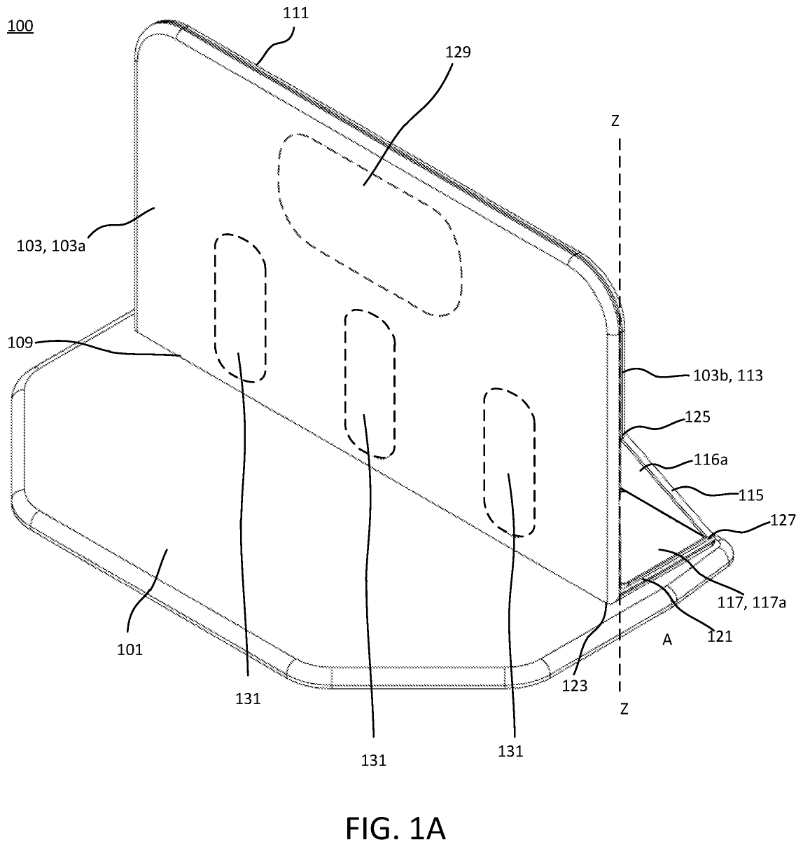

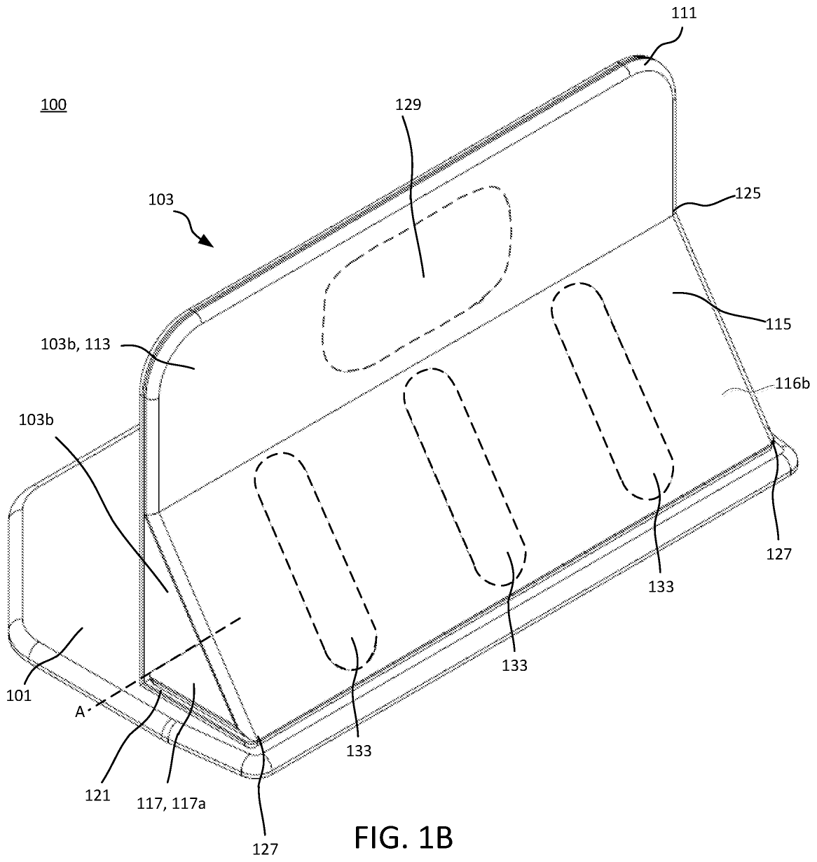

FIGS. 1A and 1B are front and rear perspective views of one example of a cargo management device consistent with the present disclosure, in a deployed state. As shown, cargo management device 100 includes a base 101 and a primary wall 103 coupled to the base 101. The primary wall 103 has a first side 103a, a second side 103b, a bottom 109, and a top 111. An offset 113 may be integral with or coupled to the primary wall 103. When integral with primary wall 103, the offset 113 may be understood as a thickened region of primary wall 103. When it is coupled to primary wall 103, offset 103 may be understood as a layer of material that is coupled to primary wall 103 in any suitable manner, such as with an adhesive or a fastener. In any case, the offset 113 forms part of the second side 103b of primary wall 103, and so is labeled accordingly. The thickness of the offset 113 may be the same as or differ from the thickness of cross member 115. In embodiments, the thickness of offset 113 is substantially the same as the thickness of cross member 115.

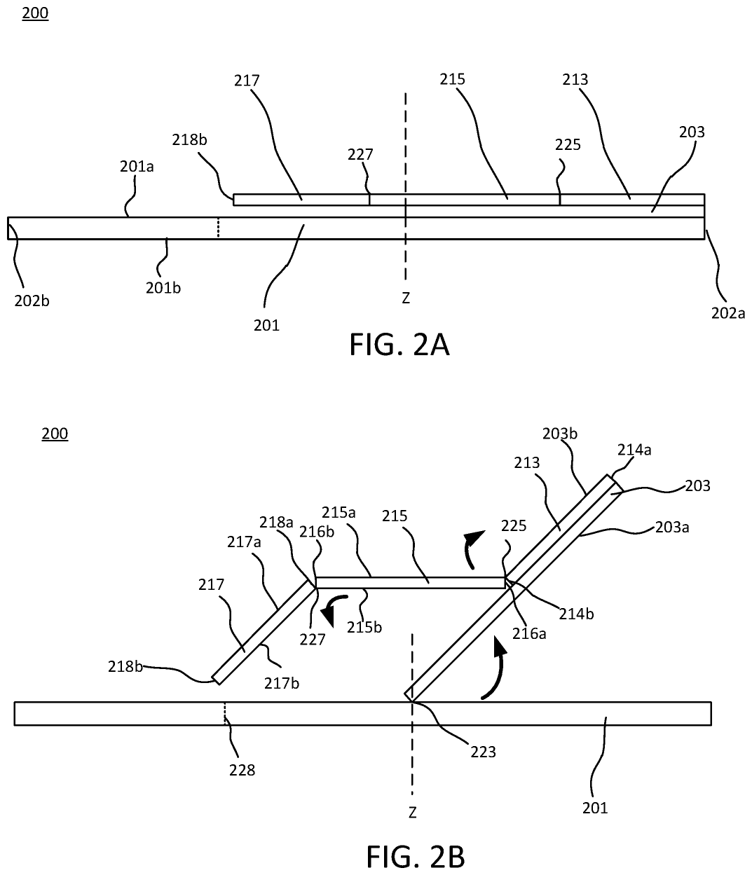

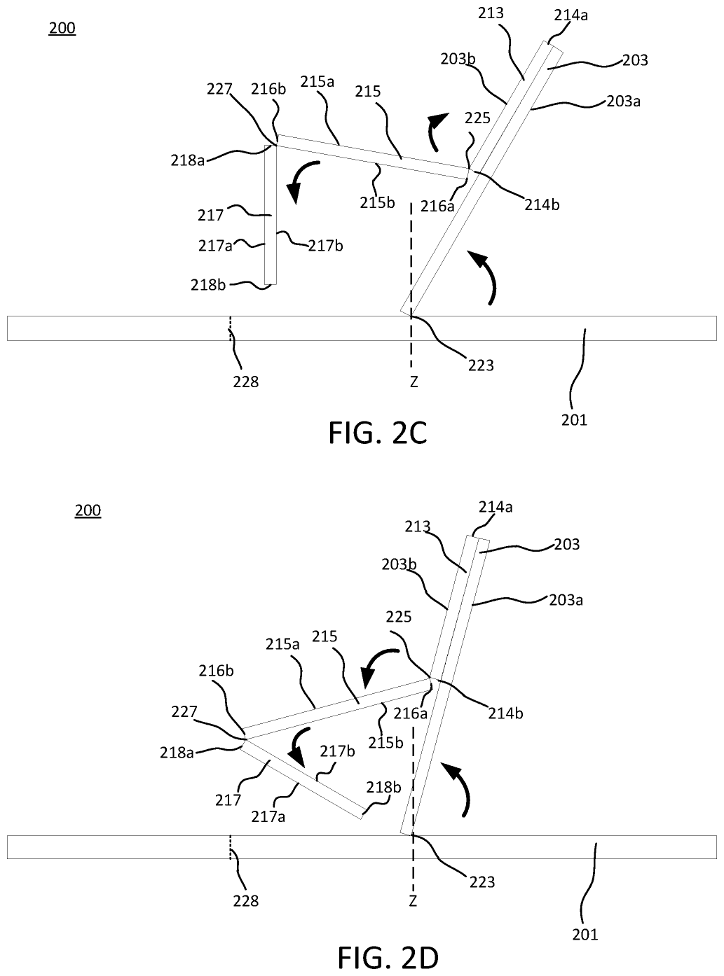

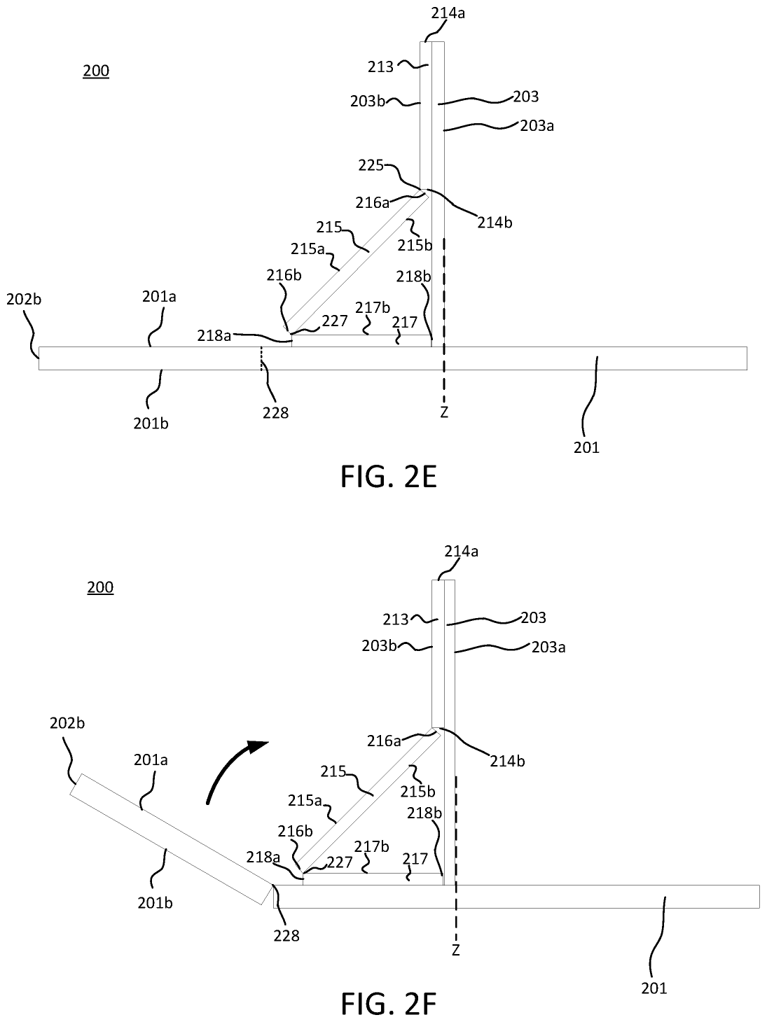

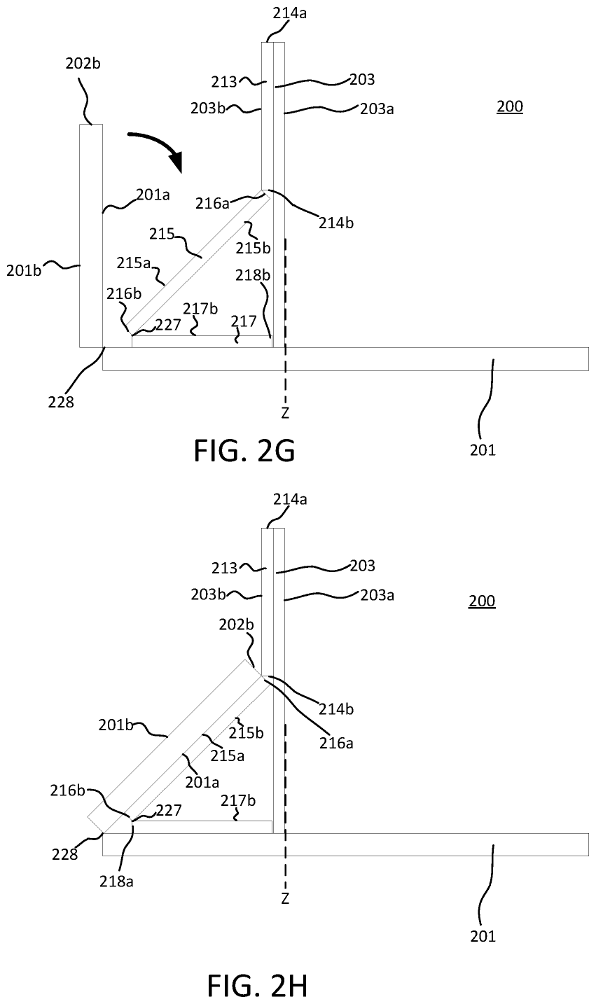

A first hinge 123 is defined between primary wall 103 and base 101. The primary wall 103 can rotate about the first hinge 123 toward or away from a first axis Z (also referred to as the “first axis” or “axis Z”). In the deployed state and as shown in FIGS. 1A and 1B, primary wall 103 is oriented parallel or substantially parallel to axis Z. Like the embodiments described later in connection with FIGS. 2A-4J, cargo management device 100 may transition to a collapsed state in which primary wall 103 is oriented perpendicular or substantially perpendicular to axis Z.

Cargo management device 100 further includes a cross member 115, a foot 117, and support 121. Cross member 115 has a first side 116a and a second side 116b, and foot 117 has a first side 117a and a second side (not shown). A proximal end (not labeled in FIGS. 1A and 1B) of cross member 115 is coupled to primary wall 103 and/or a distal end of offset 113, such that a second hinge 125 is defined between cross member 115 and primary wall 103 and/or the distal end of offset 113. A distal end (also not labeled in FIGS. 1A and 1B) of cross member 115 is coupled to a proximal end of foot 117, such that a third hinge 127 is defined between cross member 115 and foot 117. Support 121 may be integral with or coupled to the top of base 101, and may include a shoulder (not labeled) that abuts part of second side 103b of primary wall 103 when cargo management device 100 is in the deployed state. When integral with base 101, support 121 may be understood to be a thickened region of base 101. When it is not integral with base 101, support 121 may be in the form of a layer of material that is coupled to base 101 in any suitable manner, such as with an adhesive or a fastener. In embodiments, support 121 has a thickness that is the same or differs from the thickness of primary wall 103. For example, support 121 may have a thickness that is less than or equal to the thickness of primary wall 103 between the first hinge 123 and the second hinge 125.

When cargo management device 100 is in the deployed state, cross member 115 is positioned at an angle relative to axis Z, and foot 117 is disposed on or proximate to base 101 (or, more particularly, to support 121) and is oriented perpendicular or substantially perpendicular to axis Z. Moreover, primary wall 103 is oriented parallel or substantially parallel to axis Z, and a portion of second side 103b abuts a shoulder defined at least in part by one side of support 121. In addition, a distal end of foot 117 is positioned proximate to or abuts second side 103b (e.g., at a first position), and a proximal end of cross member 115 abuts second side 103b (e.g., at a position that is further away from base 101 than the first position). More particularly, the proximal end of cross member 115 may engage a shoulder, groove, or other feature on the second side 103b of primary wall 103 (not shown). For example the proximal end of cross member 115 may engage a shoulder formed at the interface between an end of offset 113 and the remainder of primary wall 103. In any case, cross member 115, foot 117, and support 121 may each buttress the second side 103b of primary wall 103 against forces applied to first side 103a of primary wall 103. In embodiments and as shown in FIGS. 1A and 2A, a triangular shaped cavity (not labeled) may be defined between the second side 103b, cross member 115 and foot 117 when cargo management device 100 is in the deployed state.

Cargo management device 100 optionally further includes a handle 129, primary wall reinforcements 131, and cross member reinforcements 133. Handle 129 may be any suitable structure that facilitates gripping and rotation of primary wall 103 about the first hinge 123. In embodiments, handle 129 is or includes an opening (e.g., a grommet) through primary wall 103 and/or offset 113.

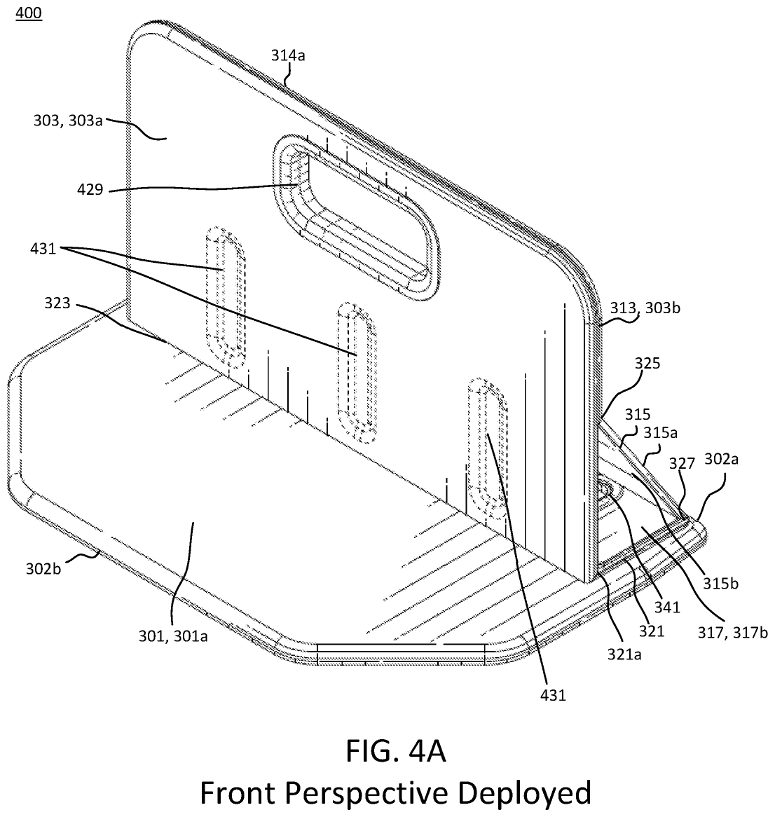

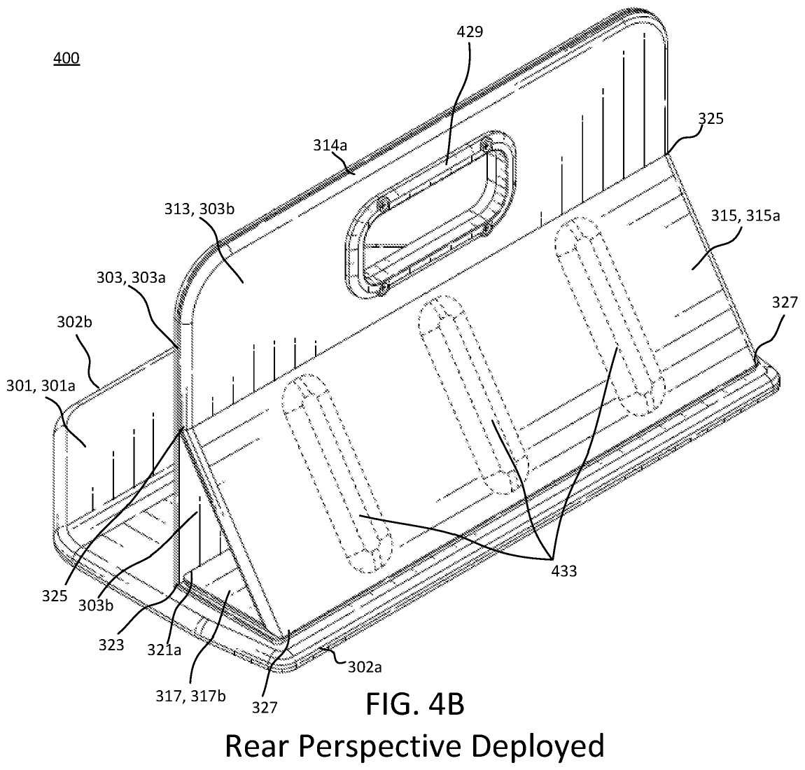

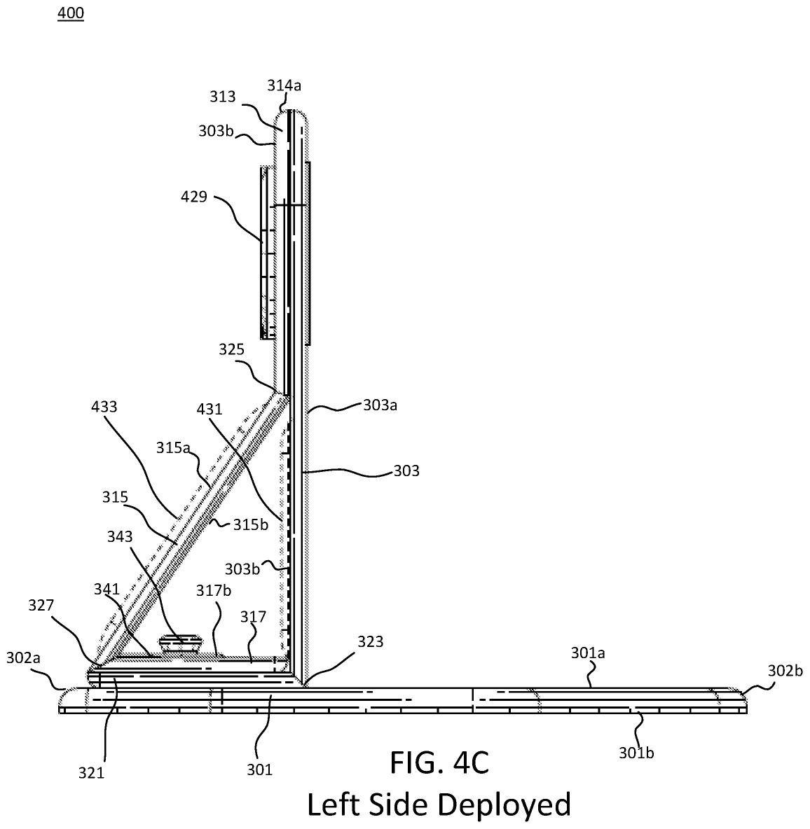

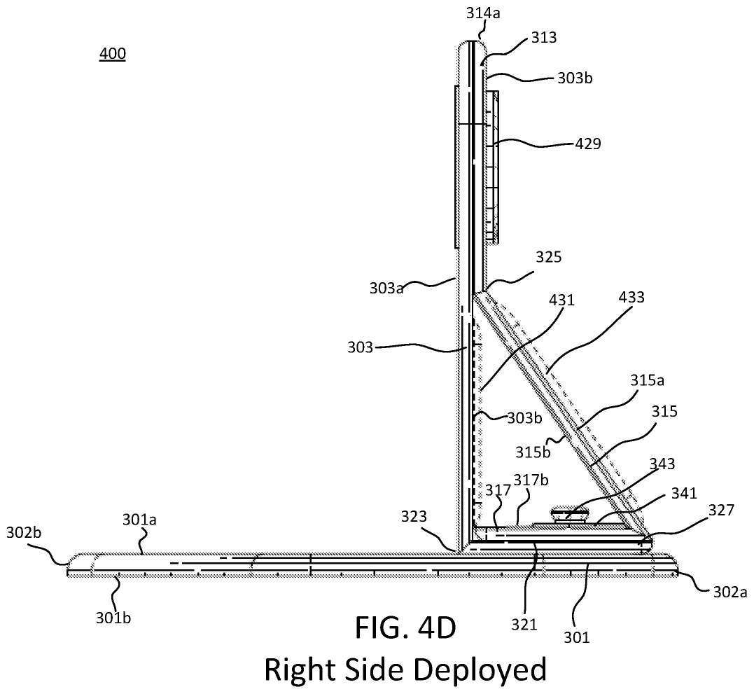

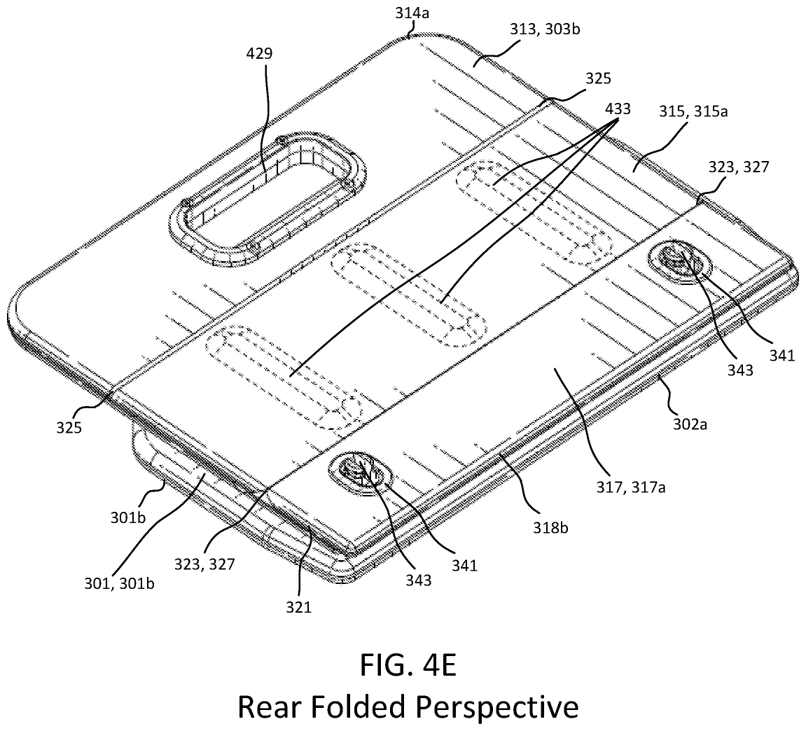

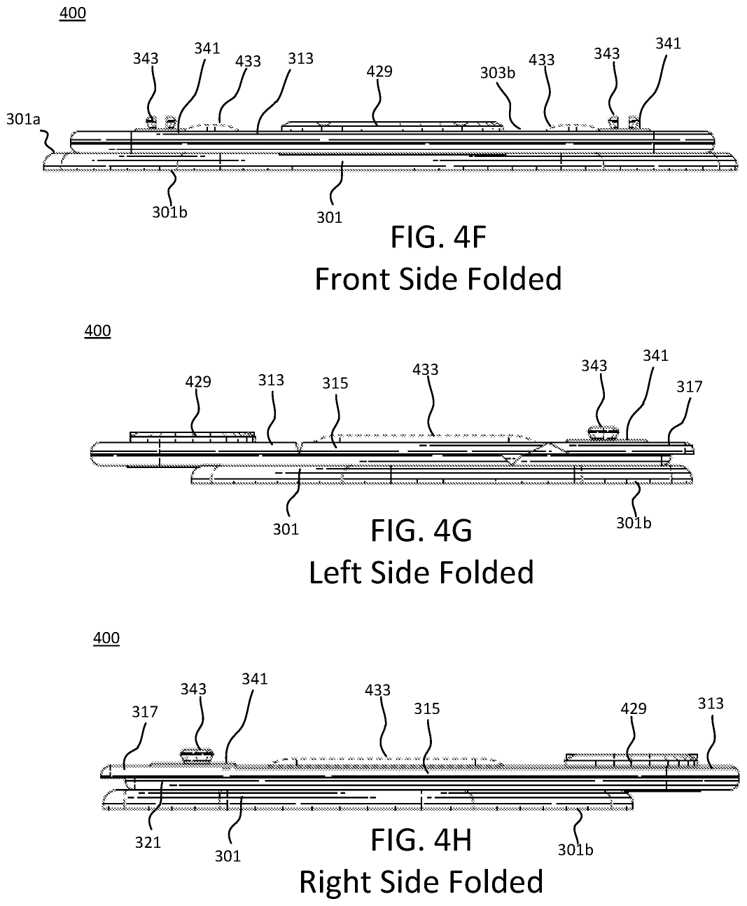

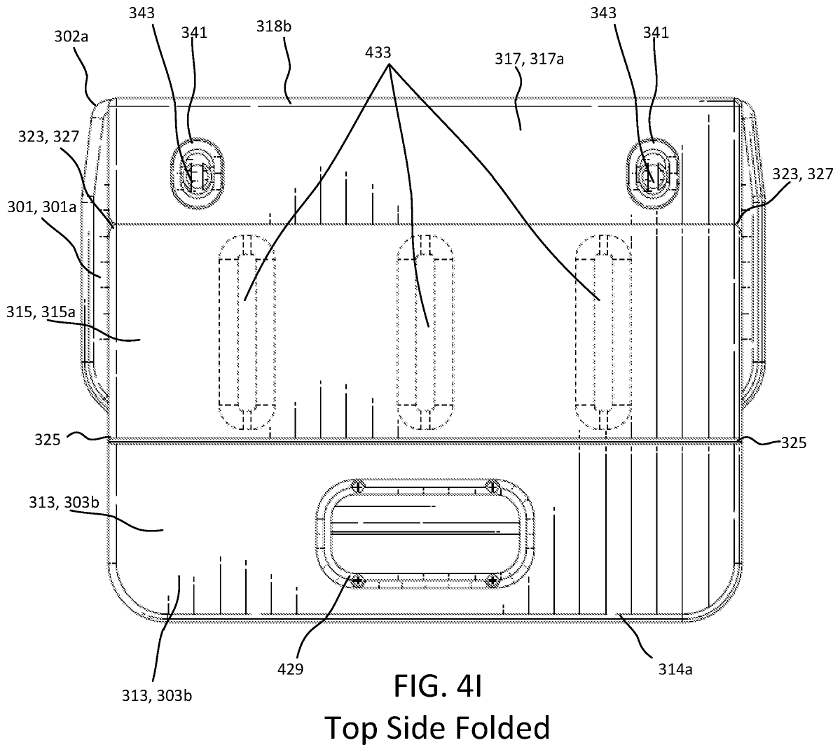

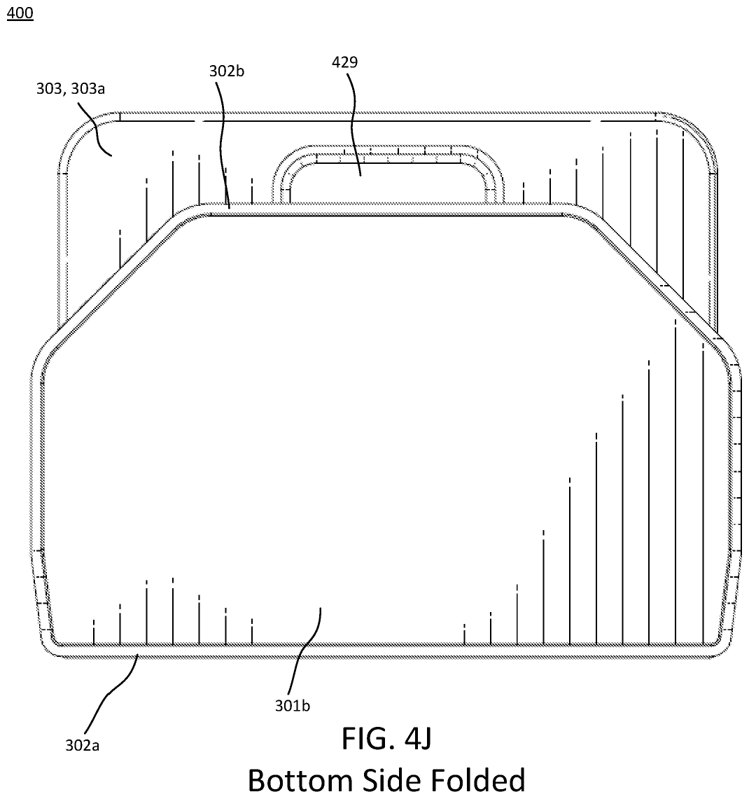

When used, primary wall reinforcements 131 and cross member reinforcements 133 generally function to increase the strength and/or rigidity of primary wall 103 and cross member 115, respectively. Any suitable reinforcements may be used as primary wall reinforcements 131 and cross member reinforcements 133. In embodiments, primary wall reinforcements 131 and cross member reinforcements 133 are configured to increase the strength and/or rigidity of their respective components, and to nest within one another when cargo management device 100 is in a collapsed (folded state). In that regard and as will be described later in conjunction with FIGS. 4A-4J, in embodiments primary wall reinforcements 131 are indentations in first side 103a and protuberances extending from second side 103b of primary wall 103, and cross member reinforcements 133 are in the form of indentations in first side 116a and protuberances extending from second side 116b of cross member 115. The indentations in first side 116a may be sized and configured to receive the protuberance extending from side 103b when cargo management device 100 is in the collapsed state. In that way, primary wall reinforcements 131 and cross member reinforcements 133 may nest together when cargo management device 100 is in the collapsed state, allowing the cargo management device to have a relatively flat profile in the collapsed state.

FIGS. 2A-2H schematically illustrate another example of a cargo management device consistent with the present disclosure as it transitions between a collapsed state (FIG. 2A), a deployed state (FIG. 2E), and a reinforced state (FIG. 2H). As shown, cargo management device 200 includes a base 201 with a top 201a, a bottom 201b, a first end 202a, and a second end 202b. A primary wall 203 is coupled to top 201a of base 201, such that a first hinge 223 is formed between base 201 and primary wall 203. The primary wall 203 includes a first side 203a and a second side 203b. In the collapsed state: primary wall 203 is disposed on or substantially on base 201 and extends perpendicular or substantially perpendicular to an axis Z extending through base 201; the first side 203a is oriented to face base 201; and second side 203b is oriented to face away from base 201.

Cargo management device 200 further includes a primary wall offset 213 (hereinafter, offset 213), which is coupled to or integral with the second side 203b of primary wall 203, e.g., in the same manner as offset 113. In either case, the exposed side of the offset 213 forms part of the second side 203b of the primary wall 203.

Offset 213 includes a proximal end 214a disposed proximate to the top of primary wall 203, and a distal end 214b that is disposed proximate to base 201. As shown, the distal end 214b is offset from the top of primary wall 203 and is located such that it abuts the proximal end of cross member 215 when cargo management device 200 is in the deployed state. In embodiments, proximal end 214a is positioned at or near the top of primary wall 203, and distal end 214b is positioned away from the top of primary wall 203 at a distance that is less than the total length of primary wall 203. For example, primary wall 203 may have a length (as measured from base 201 to the top of primary wall 203) of 4 to 24 inches, and distal end 214b is positioned 1 to 15 inches from the top of primary wall 203.

Cargo management device 200 further includes cross member 215 and foot 217. Cross member 215 has a first side 215a, a second side 215b, a proximal end 216a, and a distal end 216b. Foot 217 has a first side 217a, a second side 217b, a proximal end 218a, and a distal end 218b. The proximal end 216a of cross member 215 is coupled to the distal end 214b of offset 213, such that a second hinge 225 is formed between distal end 214b of offset 213 and the proximal end 216a of cross member 215. The proximal end 218a of foot 217 is coupled to the distal end 216b of cross member 215, such that a third hinge 227 is formed between distal end 216b and proximal end 218a.

The first hinge 223 is generally configured to allow primary wall 203 to rotate relative to base 201 as cargo management device 200 transitions from a collapsed state to a deployed state, and vice versa. Similarly, the second hinge 225 permits cross member 215 to rotate relative to primary wall 203, and the third hinge 227 permits foot 217 to rotate relative to cross member 215. With that in mind, the present disclosure will now describe the transition of cargo management device 200 from a collapsed state to a deployed state with reference to FIGS. 2A-2E.

As noted above, FIG. 2A depicts cargo management device 200 in a collapsed state. In that state, the first side 203a of primary wall 203 is disposed on or proximate to the top 201a of base 201, and is oriented perpendicular or substantially perpendicular to axis Z. At least a portion of the second side 215b of cross member 215 is disposed on or proximate to the second side 203b of primary wall 203. Moreover, in the collapsed state the second side 217b of foot 217 is oriented towards base 201, and the first side 217a is oriented away from base 201. Although not required, as shown in this embodiment the second side 203b (in the region of offset 213), the second side 215b, and the second side 217b may all lie on the same or substantially the same plane when cargo management device is in the collapsed state.

FIGS. 2B-2E show the transition of cargo management device 200 from the collapsed state to the deployed state in stepwise fashion. As best shown in FIG. 2B, the transition from the collapsed state to the deployed state may begin by rotating primary wall 203 in a first rotational direction about the first hinge 223. During that rotation the first side 203a of the primary wall 203 is moved away from the top 201a of base 201, and the second side 203b is moved toward axis Z. Simultaneously or at a different time, cross member 215 is rotated in a second rotational direction about the second hinge 225, displacing the second side 215b of cross member 215 away from second side 203b of primary wall 203. Simultaneously or at a different time as the rotation of cross member 215, foot 217 is rotated in the first rotational direction about the third hinge 227. As foot 217 is rotated about the third hinge in the first rotational direction, second side 217b is oriented at an angle relative to the top 201a of base 201, and distal end 218b begins to move toward primary wall 203.

In embodiments the first and second rotational directions are substantially opposite to one another. For example, in some embodiments the first direction is counterclockwise, and the second direction is clockwise. In other embodiments the first direction is clockwise, and the second direction is counter clockwise. In any case, the first, second, and third, hinges may each rotate about different rotational axes, e.g., axes that are positionally offset from one another and which correspond to the first, second, and third hinges, respectively.

As shown in FIG. 2C the transition between the collapsed state and the deployed state may continue by further rotating the primary wall 203 in the first direction about the first hinge 223, further rotating cross member 215 in the second direction about the second hinge 225, and further rotating foot 217 in the first direction about the third hinge 227. Rotation of the cross member 215 in the second direction about the second hinge 225 may continue until the distance between the distal end 216b and top 201a of base 201 is greater than or equal to the length of foot 217. At that point, foot 217 may be further rotated in the first direction about the third hinge 227 to bring distal end 218b towards second side 203b of primary wall 203, during which the first side 217a is brought to face towards top 201a of base 201.

Once distal end 218b is proximate to second side 203b, the primary wall 203, cross member 215, and foot 217 may all be rotated about their respective hinges in the first direction as shown in FIG. 2D. That rotation may continue until the first side of 217a of the foot 217 is brought into contact with or in proximity to top 201a as shown in FIG. 2E, at which point cargo management device 200 is in the deployed state. As further shown in FIG. 2E, in the deployed state the proximal end 216a of cross member 215 abuts distal end 214b of offset 213, distal end 218b of foot 217 abuts or is in proximity to second side 203b of primary wall 203, and first side 217a of foot 217 is disposed on or adjacent top 201a of base 201. In that position, cross member 215 and foot 217 will each support primary wall 203 against forces applied to the first side 203a.

Although not shown in the embodiment of FIGS. 2A-2H, cargo management device 200 may include a first retention system to limit or prevent movement of foot 217 when cargo management device 200 is in the deployed state. The first retention system may include or be in the form of one or more fasteners that couple the first side 217a of foot 217 to the top 201a of base 201. For example, the first retention system may include or be in the form of a hook a loop fastener, a mechanical latch, a snap fitting, a grommet and post, or the like, respective parts of which may be disposed on first side 217a and top 201a such that they align and engage one another when cargo management device 200 is in the deployed state. Alternatively, the first retention system may include magnets of opposing polarity that are be disposed on first side 217a and top 201a, and which are positioned such that they align with and attract one another when cargo management device 200 is in the deployed state.

Although useful in the deployed state shown in FIG. 2E, in some embodiments cargo management device 200 can also transition between the deployed state and a reinforced state. Transition from the deployed state to the reinforced state is described below in conjunction with FIGS. 2E-2H.

To enable transition to the reinforced state, an optional fourth hinge 228 may be defined defined/disposed between a first part of base 201 (first base part) and a second part of base 201 (second base part). As best shown in FIGS. 2F-2H, the optional fourth hinge 228 is generally configured to enable the first base part to rotate in the second rotational direction towards the axis Z. During that rotation, the top 201a of the first base part moves toward the axis Z, as shown in FIGS. 2F and 2G. The rotation continues until, as shown in FIG. 2H, the top 201a of the first base part is disposed over at least a portion of the first side 215a of cross member 215 and the second end 202b of base 201 abuts the second side 203b of offset 213—at which point the cargo management device 200 is in the reinforced state. In that state the first base part provides further support to primary wall 203 against forces applied to the first side 203a, and thus reinforces the support provided to primary wall 203 by cross member 215 and foot 217.

Cargo management device 200 may also include a second retention system to couple the top 201a of the first base part to the first side 215a of cross member 215 when the cargo management device 200 is in the reinforced state Like the first retention system, the second retention system may include or be in the form of one or more fasteners that couple the top 201a to the first side 215a of cross member 215 when cargo management device 200 is in the reinforced state. For example, the second retention system may include or be in the form of a hook a loop fastener, a mechanical latch, a snap fitting, or the like, respective parts of which may be disposed on first side 217a and top 201a such that they align and engage with one another when cargo management device 200 is in the reinforced state. Alternatively, the second retention system may include magnets of opposing polarity that may be disposed on top 201a and first side 215a, and which are positioned such that they align with and attract one another when cargo management device 200 is in the reinforced state.

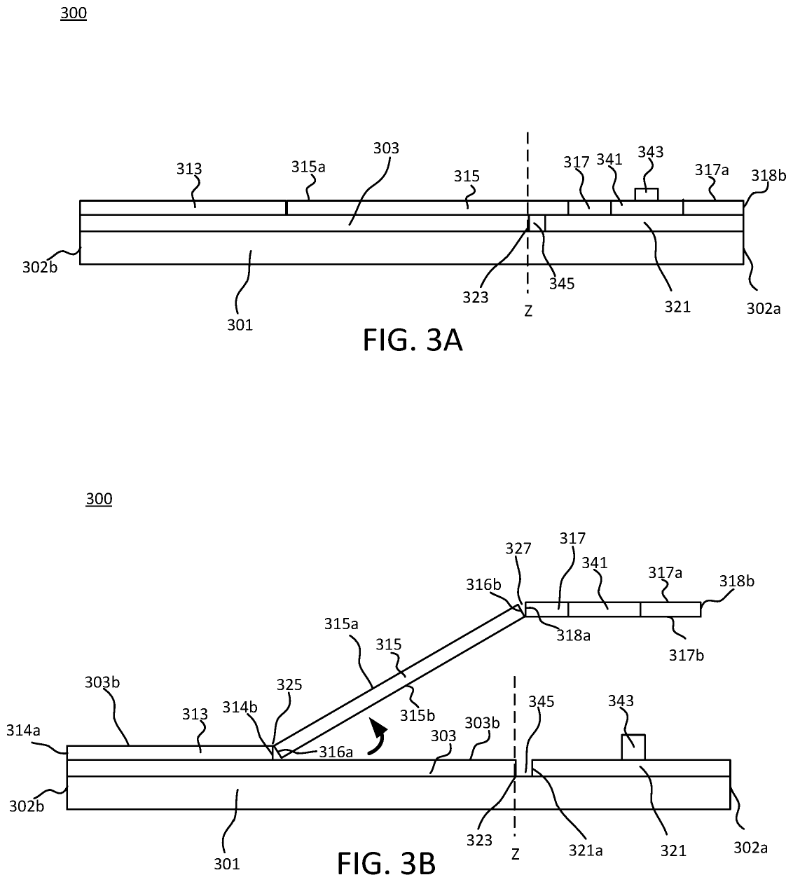

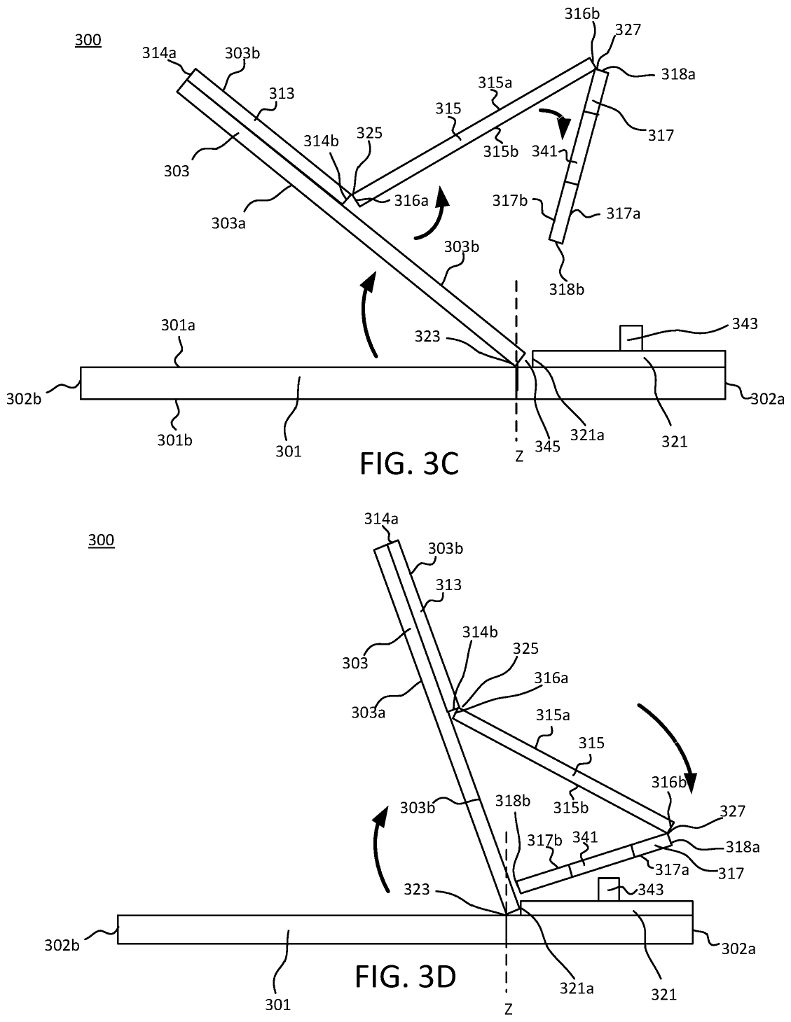

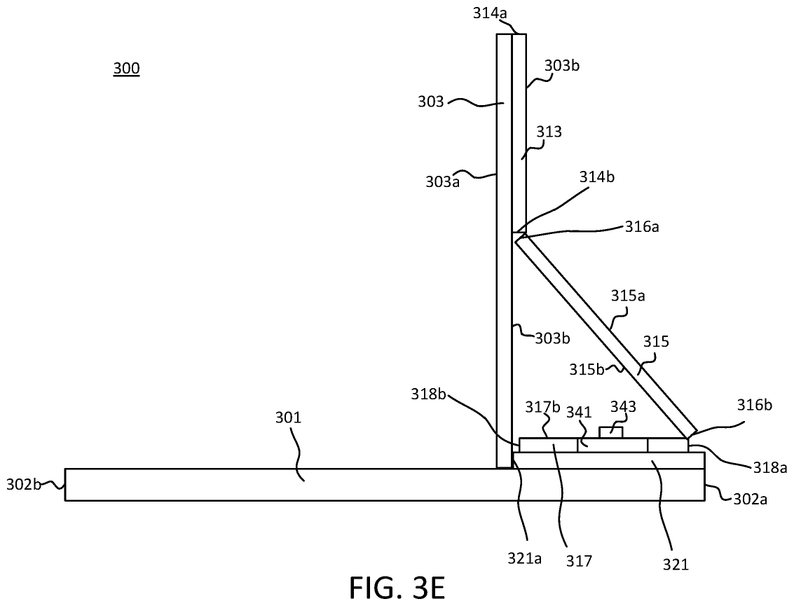

FIGS. 3A-3E schematically illustrate another example of a cargo management device consistent with the present disclosure, as it transitions between a collapsed state (FIG. 3A) and a deployed state (FIG. 3E). Cargo management device 300 includes a base 301 with a top 301a, a bottom 301b, a first end 302a, and a second end 302b. A primary wall 303 is coupled to top 301a of base 301, such that a first hinge 323 is formed between base 301 and primary wall 303. The primary wall 303 includes a first side 303a and a second side 303b. In the collapsed state (FIG. 3A): primary wall 303 is disposed on or substantially on top 301a of base 301, and extends perpendicular or substantially perpendicular to an axis Z extending through base 301; the first side 303a is oriented to face base 301; and the second side 303b is oriented to face away from base 301.

Cargo management device 300 further includes a primary wall offset 313 (hereinafter, offset 313), which is coupled to or integral with the second side 303b of primary wall 303 in the same manner as offset 113 and offset 213. Offset 313 includes a proximal end 314a disposed proximate to the top of primary wall 303, and a distal end 314b that is disposed proximate to base 301. As shown, the distal end 314b is offset from the top of primary wall 303 and is located such that it abuts the proximal end of cross member 315 when cargo management device 300 is in the deployed state. In embodiments, proximal end 314a is positioned at or near the top of primary wall 303, and distal end 314b is positioned away from the top of primary wall 103 at a distance that is less than the total length of primary wall 303. The dimensions and configuration of such components may be the same of different from the corresponding components of FIGS. 2A-2H.

Cargo management device 300 further includes cross member 315 and foot 317. Cross member 315 has a first side 315a, a second side 315b, a proximal end 316a, and a distal end 316b. Foot 317 has a first side 317a, a second side 317b, a proximal end 318a, and a distal end 318b. The proximal end 316a of cross member 315 is coupled to the distal end 314b of offset 313, such that a second hinge 325 is formed between distal end 314b of offset 313 and the proximal end 316a of cross member 315. The proximal end 318a of foot 317 is coupled to the distal end 316b of cross member 315, such that a third hinge 327 is formed between distal end 316b and proximal end 318a. Consistent with the foregoing discussion, the first hinge 323 allows primary wall 303 to rotate relative to base 301 as cargo management device 300 transitions from a collapsed state to a deployed state, and vice versa. Similarly, the second hinge 325 allows cross member 315 to rotate relative to primary wall 303, and the third hinge 327 allows foot 317 to rotate relative to cross member 315. Rotation about the first, second, and third hinges may occur in first and second directions (e.g., counterclockwise and clockwise), with such rotation occurring about different rotational axes.

Cargo management device 300 further includes a retention support 321, which is integral with or coupled to base 301 in the same manner as support 121. In embodiments, retention support 321 is integral with and forms a thickened part of base 301. In any case, retention support 321 includes an abutment surface 321a, which abuts or is disposed proximate to a portion of the second side 303b of primary wall 303 when cargo management device 300 is in the deployed state. A gap 345 may be present between the bottom of primary wall 303 and the abutment surface 321a when cargo management device 300 is in the collapsed state, as best shown in FIG. 3A. Generally, gap 345 provides clearance for the rotation of primary wall 303 from the collapsed state to the deployed state, or vice versa.

Cargo management device 300 further includes a retention system for retaining the position of foot 317 relative to the retention support 321 in the deployed and collapsed states. In the illustrated embodiment the retention system includes a grommet 341 formed through foot 317, and a post 343 that is integral with or coupled to retention support 321 and/or base 301. Post 343 and grommet 341 are positioned and configured such that post 343 extends through grommet 341 from the second side 317b to the first side 317a of foot 317 when cargo management device 300 is in the collapsed state. In contrast, post 343 and grommet 341 are positioned and configured such that post 343 extends through grommet 341 from the first side 317a to the second side 317b of foot 317 when cargo management device 300 is in the deployed state. In either state, extension of post 343 through grommet 341 may limit or prevent movement of foot 317 relative to base 301. Although not shown, in embodiments post 343 may include elements that facilitate its retention within grommet 341, but allow it to be removed therefrom by the application of a force. For example, post 343 may include one or more angled shoulders that allow it to be disposed through grommet 341 with the application of force in a first direction, and to be removed from grommet 341 by the application of force in a second direction that differs from the first direction.

The present disclosure will now describe the transition of cargo management device 300 from a collapsed state to a deployed state with reference to FIGS. 3A-3E. In the collapsed state of FIG. 3A: the first side 303a of primary wall 303 is disposed on or proximate to the top 301a of base 301 and is oriented perpendicular or substantially perpendicular to axis Z; and at least a portion of the second side 315b of cross member 315 is disposed on or proximate to the second side 303b of primary wall 303. In embodiments and as shown in FIG. 3A: at least portion of the second side 315b of cross member 315 is also disposed on or proximate to retention support 321; the second side 317b of foot 317 is oriented towards base 301; and the first side 317a is oriented away from base 301. The second side 317b is also disposed on or proximate to retention support 321, such that post 343 extends through grommet 341. Although not required, as shown in this embodiment the second side 303b (in the region of offset 313), the second side 315b, and the second side 317b may all lie on the same or substantially the same plane when cargo management device 300 is in the collapsed state.

FIGS. 3B-3E show the transition of cargo management device 300 from the collapsed state to the deployed state in stepwise fashion. As best shown in FIG. 3B, the transition from the collapsed state to the deployed state may begin by decoupling post 343 from grommet 341. This may be accomplished by lifting foot 317 away from base 301 and rotating cross member 315 in a first rotational direction (e.g., counter clockwise) to displace second side 315b away from top 301a of base 301.

As shown in FIGS. 3B and 3C, the transition to the deployed state may continue by rotating primary wall 303 in a second rotational direction (e.g., clockwise) about the first hinge 323. During that rotation, the first side 303a of the primary wall 303 is moved away from the top 301a of base 301, and the second side 303b is moved toward axis Z. Simultaneously or at a different time, cross member 315 may be further rotated in the first rotational direction about the second hinge 325, and foot 317 may be rotated in the second rotational direction about the third hinge 327. As shown in FIGS. 3B and 3C, as foot 317 is rotated about the third hinge in the second rotational direction, the second side 317b is oriented at an angle relative to the top 301a of base 301 and distal end 318b begins to move toward primary wall 303. Rotation of the cross member 315 in the first direction about the second hinge 325 may continue until the distance between the distal end 316b and top 301a of base 301 is greater than the length of foot 317. At that point, foot 317 may be further rotated in the first direction about the third hinge 327 to bring distal end 318b towards second side 303b of primary wall 303. During that rotation, the first side 317a is brought to face towards the top 301a of base 301.

Like the embodiment(s) of FIGS. 2A-2H, in the embodiment of FIGS. 3A-3E the first and second rotational directions are substantially opposite to one another. For example, in the illustrated embodiment the first direction is counterclockwise, and the second direction is clockwise. These directions may be reversed, for example, depending on the configuration and/or orientation of cargo management device 300. In any case, the first, second, and third, hinges may each rotate about different rotational axes, e.g., axes that are positionally offset from one another.

Once distal end 318b is disposed in proximity to second side 303b, the primary wall 303, cross member 315, and foot 317 may all be rotated about their respective hinges in the second direction as shown in FIG. 3D. That rotation may continue until the first side 317a of the foot 317 is brought into contact with or in proximity to top 301a of base 301 and post 343 extends through grommet 341 as shown in FIG. 3E, at which point cargo management device 300 is in the deployed state. Notably in the deployed state, post 343 extends through grommet 341 from the first side 317a to the second side 317b of foot 317. In contrast when cargo management device is in the collapsed state (FIG. 3A), post 343 extends through grommet 341 from the second side 317b to the first side 317a of foot 317.

FIGS. 4A-4J depict another example of a cargo management device consistent with the present disclosure, in a deployed state (FIGS. 4A-4D) and a collapsed state (FIGS. 4E-4J). Cargo management device 400 includes many of the same elements as cargo management device 300. As the nature and function of such elements is the same as described above in conjunction with FIGS. 3A-3E, such elements and their operation is not described again in the interest of brevity. Rather, the following description focuses on elements of cargo management device 400 that differ from or were not depicted in cargo management device 300.

As best shown in FIGS. 4A and 4B, in addition to the elements of cargo management device 300, cargo management device 400 includes a handle 429, optional primary wall reinforcements 431 (“reinforcements 431”), and optional cross member reinforcements 433 (“reinforcements 433”). In this embodiment, handle 329 is in the form of a grommet that extends through an upper part of primary wall 303 and primary wall offset 313. For example, handle 429 may include an opening through primary wall 303 and primary wall offset 313, and a liner (e.g., a rubber or plastic liner) extending around the periphery of the opening. In any case, handle 429 is configured to facilitate gripping of cargo management device 400 and manipulation of primary wall 303, e.g., during a transition from a collapsed state to a deployed state, or vice versa. While handle 429 is depicted as defining an oval shaped opening through primary wall 303, handle 429 may have any suitable shape.

When used, reinforcements 431 generally function to reinforce primary wall 303. For example, reinforcements 431 may be configured to increase the stiffness (rigidity) of primary wall 303 in one or more dimensions. In that regard, reinforcements 431 may be in the form of or include one or more depressions in first side 303a of primary wall 303. The depressions may extend through the thickness of primary wall 303, such that corresponding protuberances extend from the second side 303b of primary wall 303. Similarly when reinforcements 433 are used, they may be in the form of or include one or more depressions in the second side 315b of cross member 315. Such depressions may extend through the thickness of cross member 315, such that corresponding protuberances extend from the first side 315a thereof. In embodiments and as shown in FIGS. 4E-4J, reinforcements 431 may be configured to nest within reinforcements 433 when cargo management device 400 is in the collapsed state. More particularly, reinforcements 431 may be in the form of or include protuberances extending from the second side 303b of primary wall 303, and reinforcements 433 may be in the form of or include recesses within the second side 315b of cross member 315. In such instances, reinforcements 431 and 433 may be sized and positioned such that when cargo management device is in the collapsed state, reinforcements 431 are at least partially disposed within reinforcements 433. As can be seen from FIGS. 4E-4J, one advantage of such a configuration is that it allows cargo management device to be substantially flat when it is in the collapsed state.

FIGS. 4A-4J show cargo management device 400 as optionally including three primary wall reinforcements 431 and three cross member reinforcements 433. Such a configuration is not required, and any suitable number of such reinforcements may be used. For example, the cargo management devices described herein may include 1, 2, 3, 4, 5, or more primary wall reinforcements 431, and a corresponding number of cross member reinforcements 433. Alternatively, the number of primary wall reinforcements 431 may differ from the number of cross member reinforcements 433. For example, in some embodiments the cargo management devices described herein may include one or more primary wall reinforcements 431, but may not include any cross member reinforcements 433. Conversely, in some embodiments the cargo management devices described herein include one or more cross member reinforcements 433, but do not include any primary wall reinforcements 431.

FIGS. 4A-4J show primary wall reinforcements 431 and cross member reinforcements 433 as extending in a generally vertical direction along the primary wall 303 and cross member 315, respectively. Such a configuration is not required, and reinforcements 431, 433 may have any suitable configuration. In embodiments, reinforcements 431, 433 are molded with their corresponding primary wall 303 and cross member 315. In any case, reinforcements 431, 433 may extend along the entire height/length of primary wall 303 and/or cross member 315, or only along a portion of the height/length of primary wall 303 and/or cross member 315, as shown.

As best shown in FIG. 4G-4J, in embodiments when cargo management device 400 is in the collapsed state, the top of primary wall 303 (e.g., as reflected by the top of offset 313) may extend past the second end 302b of base 301. Put differently—in this embodiment the primary wall has a height H1 defined between the first hinge and the top of primary wall 303, and a first distance D1 is present between first hinge 323 and the second end 302b of base 301, wherein D1 is less than H1. Of course this embodiment is for the sake of example only, and the dimensions of any element of cargo management device 400 may be set to achieve any desired aesthetic or functional purpose.

In the embodiments of FIGS. 2A-4J, the bottom (i.e., second side) of the base 201, 301 is depicted as being substantially flat. While the cargo management devices consistent with the present disclosure can be used with a flat or substantially flat base, such a configuration is not required. Indeed, in some embodiments (including those shown in FIGS. 2A-4J), the base of the cargo management devices described herein is configured to limit or prevent slipping of the cargo management device, e.g., when it is deployed in a cargo or passenger compartment of a vehicle.

In that regard, in some embodiments the cargo management devices described herein include an anchoring mechanism. The anchoring mechanism may include one or more fasteners (e.g., hook and loop fasteners, snap fit fasteners, latches etc.), one or more nibs, etc., that engage a part of the vehicle (e.g., carpet and/or fabric within a passenger or cargo compartment), or the like. Non-limiting examples of suitable hook and loop fasteners include those sold by VELCRO® of Manchester, N.H. Alternatively or additionally, when the cargo management device is to be deployed in a passenger/cargo area lined with a thermoplastic or metal liner, the anchoring mechanism may include strips of relatively low durometer polymer materials, such as silicone or thermoplastic elastomer, that preferably exhibit a relatively higher coefficient of friction against cargo liner material than the coefficient of friction exhibited by the base against the cargo liner material. For example, the anchoring mechanism may include one or more stripes of low durometer material having a durometer in the range of 60-85 Shore A.

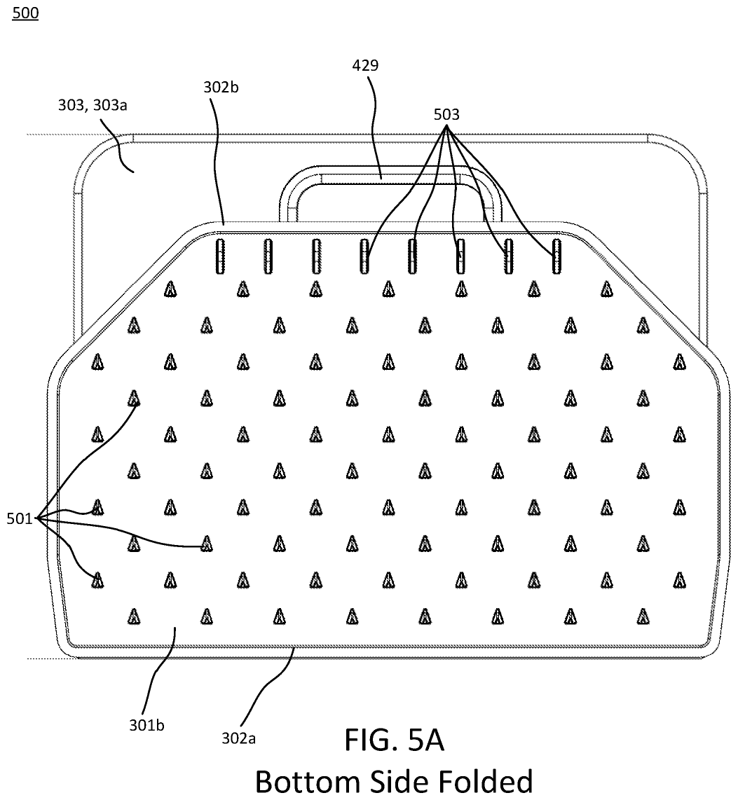

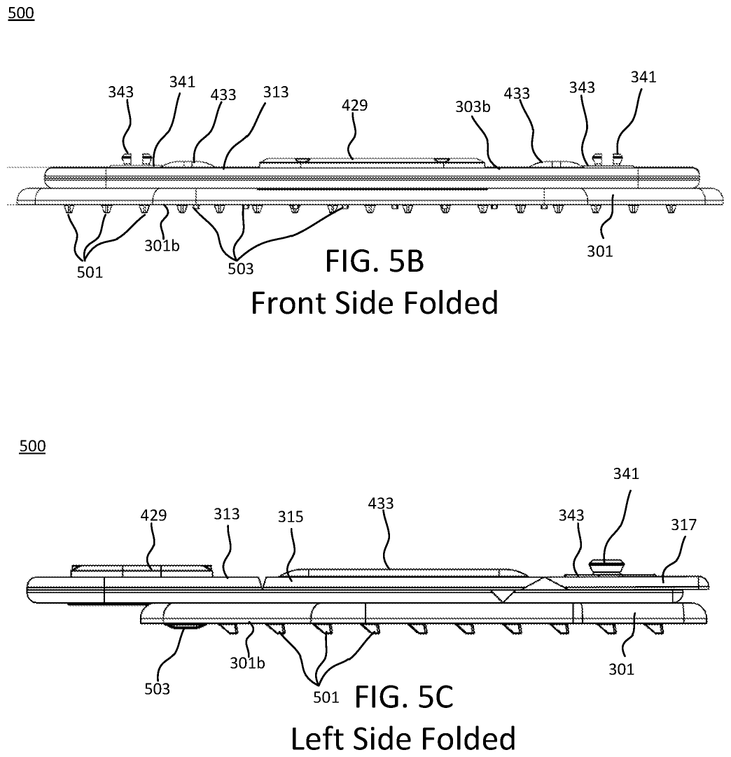

In some embodiments and as illustrated in FIGS. 5A-5C, the anchoring mechanism includes one or more projections coupled to or otherwise extending from the bottom 301b of base 301. The projections may include nibs 501 extending from the bottom 301b that may engage carpet, fabric, or liner materials used in a cargo/passenger area of a vehicle. The nibs 501 may have any suitable geometry, such as a pyramidal geometry, conical geometry, or combinations thereof. Alternatively or additionally, the nibs 501 may be of the nib design disclosed in U.S. Pre-Grant Publication 2017/0190140 and/or U.S. application Ser. No. 16/595310, the entire disclosures of both of which are incorporated by reference. More specifically, the bottom 301b includes a plurality of nibs 501 extending therefrom. The nibs 501 may be tiered and include a frusto-conical base extending from the bottom 301b and a tip extending from the frusto-conical base. The nibs 501 may have a maximum diameter in the range of 0.5 to 3.0 mm and an overall height in the range of 1.5 mm to 5 mm. Each nib 501 may be located within a column and a row, and may be offset from at least one other nib 501 present in the column and at least one other nib 501 present in the row. In embodiments, the nibs 501 form an array that is repeated on bottom 301b. In preferred embodiments, the array includes 4 columns of nibs 501 and 6 rows of nibs 501. Preferably, the nibs 501 are present at a density of 2,000 to 150,000 nibs per square meter.

In embodiments, the nibs 501 are formed on or in a backing layer that is coupled to the bottom 301b of base 301, e.g., via an adhesive or one or more fasteners. When used, the backing layer is preferably formed from a thermoplastic elastomer having an ash content in the range of 20 to 40% by weight, a melt flow index in the range of 60 grams per 10 minutes to 150 grams per 10 minutes measured at 190° C. and 21.6 kg, a tensile strength in the range of 3,000 kPa to 5,000 kPa, an elongation in the range of 450% to 700%, and a density in the range of 0.80 g/cm³ to 1.33 g/cm³. The backing layer may also be provided by thermoset elastomer (i.e. crosslinked) and may preferably be sourced from a diene rubber, such as cis-1,4-polyisoprene, or natural rubber. The thermoset elastomer may also be preferably sourced from styrene-butadiene rubber, otherwise known as SBR. Preferably, the thermoset elastomer may have a density in the range of 0.90 g/cm³ to 1.70 g/cm³. It should also be noted that the backing layer herein, whether sourced from thermoplastic elastomer and/or thermoset elastomer, may be used on its own and without the nib design noted herein. Accordingly, the surface of the thermoplastic and/or thermoset elastomer is contemplated to provide, on its own, frictional engagement with the surface of the vehicle where the cargo management may be utilized.

As best shown in FIG. 5C, the nibs 501, which are also a projection, include a frusto-conical base extending from the bottom 301b of base 301, and a tip extending from the frusto-conical base. In that nib geometry, the frusto-conical base preferably meets bottom 301b in a radius. The tip is preferably cylindrical, but may have another suitable cross-sectional geometry other than circular, such as square, rectangular, ellipsoid, etc. Further, a distal portion of the tip (i.e. the portion distal from the base) may be flat (as illustrated), rounded. or pointed. As illustrated, and preferred, at least one sidewall of the tip meets an upper surface of the frusto-conical base at an angle a of 90 degrees, however, angle a may be selected from an angle in the range of 45 to 135, including all values and ranges therein.

As may therefore be appreciated, each of the nibs 501 is preferably tiered, and may include a frusto-conical base with an upper surface and a tip extending from the upper surface, wherein the tip includes a sidewall that meets the upper surface of the frusto-conical base and the tip has a diameter that is less than the diameter of the frusto-conical.

The maximum diameter of the nibs 501 is preferably in the range of 0.5 to 3.0 mm, including all values and ranges therein, and the overall height of the nibs is preferably in the range of 1.5 mm to 5 mm, including all values and ranges therein.

As best shown in FIG. 5A, cargo management device 500 may also include a plurality of slider ribs 503 positioned proximate to the edge of the second end 302b of base 301. Side views of the nibs 501 and slider ribs 503 in FIG. 5B and SBC. The slider ribs 503, as noted, are preferably positioned proximate to second end 302b of base 301, but they may be positioned in any suitable location. In a preferred embodiment, a leading end portion of the slider ribs 503 is within 0.1 to 0.5 inches from the second end 302b of base 301.

When used, the slider ribs 503 preferably have a maximum height in the range of 2.0 mm to 3.0 mm, which then tapers and slopes towards each respective end portion thereof. The slider ribs 503 preferably have a length of 10 mm to 20 mm, more preferably 14.0 mm to 16.0 mm, and in a most preferred embodiment, a length of 15.0 mm. The slider ribs 503 also preferably have a width of 2.0 mm to 3.0 mm.

The slider ribs 503 may be spaced from one another by a distance ranging from 15.0 mm to 25.0 mm, more preferably 18.0 mm to 22.0 mm, and in a most preferred embodiment, a spacing of 20.0 mm at +/−1.0 mm. In addition, the nibs 501 are preferably arranged in parallel rows that are spaced apart by a distance ranging from 30.0 mm to 40.0 mm, more preferably 34.0 mm to 38.0 mm, and in a most preferred configuration, 36.0 mm. The nibs 501 in each row may be laterally offset by an offset distance relative to nibs in each adjacent row, such that nibs 501 in each respective row are not aligned horizontally. The offset distance may range from 15.0 mm to 20.0 mm, more preferably 17.0 mm to 19.0 mm, and more preferably at 18.0 at +/'11.0 mm.

As may be appreciated, because slider ribs 503 are placed proximate the second end 302b, they can allow a user to lift cargo management device 500 to an angle of about 4-5° from its planar position on the floor of the passenger/cargo compartment. This may cause nibs 501 to release their engagement with the liner on the passenger/cargo compartment so that the cargo management device can be conveniently repositioned.

As used herein, the term “perpendicular,” when used to describe the orientation of a first element to a second element, means that the first element (or a projection thereof) intersects or will intersect the second element (or a projection thereof) at a 90 degree angle. In contrast, the term “parallel” when used to describe the orientation of a first element to a second element means that the first element and second element each extend (i.e., have a longest linear dimension) along the same plane. In those contexts, the term “substantially” means +/−10 degrees of the indicated orientation. For example, “substantially perpendicular” means that a first element is oriented such that it or a projection thereof intersects or will intersect a second element or a projection thereof at an angle ranging from 80 to 100 degrees. Similarly, “substantially parallel” means that a first element and a second element are oriented along the same plane, or along planes that differ from one another by less than or equal to 10 degrees.

The foregoing description of several methods and embodiments has been presented for purposes of illustration. It is not intended to be exhaustive or to limit the claims to the precise steps and/or forms disclosed, and obviously many modifications and variations are possible in light of the above teaching.

What is claimed is:

1. A cargo management device, comprising:
a base having opposed top and bottom sides;
a primary wall coupled to the base by a first hinge, the primary wall comprising a first and second side; and
a foldable support coupled to the primary wall by a second hinge, the foldable support comprising a cross member coupled to a foot by a third hinge;
wherein:
the cross member comprises a first and second side;
the foot comprises a first and second side;
the cargo management device is movable between a collapsed state and a deployed state;
in the collapsed state, the primary wall, cross member, and foot are each oriented such that they extend perpendicular or substantially perpendicular to an axis Z extending through the top and bottom sides of the base, with the respective second sides of the primary wall, cross member, and foot facing the top of the base; and
in the deployed state:
the primary wall is oriented parallel or substantially parallel to an axis Z that extends through the top and bottom sides of the base,
the foot is disposed and extends parallel or substantially parallel to the top of the base; and
the cross member extends at an angle between the primary wall and a distal end of the foot.

2. The cargo management device of claim 1, wherein in the deployed state, the first side of the foot faces the top of the base.

3. The cargo management device of claim 2, wherein the foot further comprises a proximal end, and in the deployed state, the proximal ends of the foot abuts a part of the second side of the primary wall.

4. The cargo management device of claim 1, further comprising a retention system to limit or prevent movement of the foot relative to the base in the deployed state.

5. The cargo management device of claim 4, wherein:
the retention system comprises a grommet through the foot and a post coupled to the base; and
in the deployed state, the post extends through the grommet from the first side to the second side of the foot.

6. The cargo management device of claim 5, wherein in the collapsed state, the post extends through the grommet from the second side to the first side of the foot.

7. The cargo management device of claim 1, further comprising an anchoring mechanism coupled to the bottom side of the base.

8. The cargo management device of claim 7, wherein the anchoring mechanism includes a plurality of nibs.

9. The cargo management device of claim 8, wherein each of the nibs comprises a frustoconical base and a tip.

10. The cargo management device of claim 8, further comprising a plurality of slider ribs that are configured to enable the cargo management device to slide against a cargo liner of a passenger or cargo compartment of a vehicle.

11. The cargo management device of claim 10, wherein the slider ribs are positioned proximate an edge of the base.

12. The cargo management device of claim 1, wherein the first, second, and third hinges can each rotate in a first rotational direction and a second rotational direction opposite or substantially opposite the first rotational direction.
